(19) United States
(12) Patent Application Publication
(10) Pub. No.: US 2025/0386830 A1
(43) Pub. Date: Dec. 25, 2025

(54) CONVEYING SYSTEM AND METHOD USING SUCH A SYSTEM

(71) Applicant: VELEC SYSTEMS, WATTRELOS (FR)

(72) Inventors: Rémy LEQUERTIER, WATTRELOS (FR); Marie-Noëlle DEFRANCE, WATTRELOS (FR); Florian GHESTEM, WATTRELOS (FR)

(73) Assignee: VELEC SYSTEMS, WATTRELOS (FR)

(21) Appl. No.: 19/238,781

(22) Filed: Jun. 16, 2025

(30) Foreign Application Priority Data
Jun. 21, 2024 (FR) 2406695

(51) Int. Cl. A22C 11/00; B65G 15/42

(52) U.S. Cl. CPC A22C 11/008; B65G 15/42; B65G 2201/0217

(57) ABSTRACT

A conveying system for elongate products, such as sausages, includes a first conveyor having:
at least one conveyor belt having an inner face and an outer face, and guide wheels for the at least one conveyor belt configured to engage with the inner face of the at least one conveyor belt. At least one support includes a housing extending in length configured for receiving an elongate product, an attaching member attaching the at least one support to the at least one conveyor belt, ensuring attachment of the at least one support, locally, in a direction transverse to the conveyor belt including pairs of attachment groove and attachment rib (Na).

### FIELD

The present disclosure relates to a conveying system for elongate products, such as sausages, comprising at least one conveyor belt, and one or more supports forming respectively one or more housings for elongate products, the housing or housings extending transversely to the forward direction of said at least one conveyor belt.

The present disclosure relates more particularly to at least one such conveying system, which comprises several groups of supports, namely at least one first group of first supports, and a second group of second supports, driven respectively by a first pair of conveyor belts, and a second pair of conveyor belts, the conveyor belts of the first pair and that of the second pair being independently driveable.

The present disclosure finds a particular application in the food field requiring a high level of hygiene and cleanability. For information, elongate products may be sausages.

The present disclosure also relates to a method for conveying food products, using the conveying system according to the present disclosure, in particular serving as a buffer between an automated continuous flow line of elongate products, and an automated packaging station operating in batch mode, such as for example a thermoforming machine.

The present disclosure further relates to a method for cleaning a conveying system according to the present disclosure.

The present disclosure relates to the field of conveying systems comprising one or more conveyor belts, and several housings for elongate products, extending parallel to each other with respect to the forward direction of the conveyor in controlled positions on the conveyor belt(s), and which is typically known as a “piano conveyor” to those skilled in the art.

Such a conveyor makes it possible to control the positioning of the elongate products, in the forward direction of the conveyor surface, the products being housed individually in the positions of the housings.

### BACKGROUND

Thus a conveying system is known from the prior art for which the different individual housings are formed by supports formed as separate elements of conveyor belts, and which are fastened to external surfaces of the conveyor belts.

To do this, fastening members, typically bolts, simultaneously pass through the support and the conveyor belts according through their thickness.

According to the findings of the inventors, a first defect of such a fastening solution is that the fastening members, i.e. the bolts, when incorrectly mounted, can protrude from the inner guiding face of the belt intended to engage with guide wheels, and thus be the cause of disturbance to guidance. A second defect of such a solution is that it requires drilling of the conveyor belt, and this gives rise to gaps at the holes, i.e. between the bolt and the belt, gaps where moisture can be trapped and promote the development of pathogens.

According to the findings of the inventors, such a prior art can be improved, in particular with regard to cleanability or hygiene and in particular in applications in the food field.

### SUMMARY

The present disclosure will improve the situation.

According to a first aspect, a conveying system for elongate products, such as sausages, is proposed, comprising a first conveyor having:
at least one conveyor belt having an inner face and an outer face, and guide wheels for said at least one conveyor belt configured to engage with the inner face of said at least one conveyor belt,
at least one support, comprising a housing extending in length configured to receive an elongate product,
means for fastening said at least one support to said at least one conveyor belt, ensuring fastening of said at least one support, locally oriented, in a direction transverse to said conveyor belt.

According to the present disclosure, said attachment means comprise:
a groove for attaching said at least one support having at least one open longitudinal end, extending longitudinally to the support,
an attachment rib, integral with the outer face of said at least one conveyor belt, extending transversely to the local direction of said at least one belt, allowing fastening of said at least one support to said conveyor belt by inserting the attachment rib into said attachment groove by said open longitudinal end, and fitting the rib as far as a locking position of the attachment rib in the attachment groove ensuring the attachment of the at least one support on said at least one belt,
stop means, ensuring a locking of the attachment rib in the attachment groove in the locking position by preventing the sliding of the attachment rib along the attachment rib.

The features outlined in the following paragraphs can optionally be implemented independently or in combination with one another.

According to one embodiment, the stop means are configured to be moved manually by an operator, from a position ensuring the locking of said at least one support on said at least one conveyor belt, and as far as an escape position of the stop means releasing the sliding, allowing the detachment of said at least one support from said conveyor belt by sliding extraction of the attachment rib from the attachment groove.

In particular, and according to one embodiment:
said at least one support comprises at least one first support, or even first supports and at least one second support, or even second supports, or at least one third support, or even third supports
said at least one conveyor belt comprises:
   a first pair of conveyor belts to which the or each first support is fastened, by first attachment ribs, conveyor belts of the first pair of belts, fitted into the attachment groove of the first support
a second pair of conveyor belts on which the or each second support is fastened by second attachment ribs of the conveyor belts of the second pair of belts, fitted into the attachment groove of the second support,
or even a third pair of conveyor belts to which the or each third support is fastened, by third attachment ribs of the conveyor belts of the third pair of belts, fitted into the attachment groove of the third support, and
   and wherein said first conveyor has a drive mechanism comprising:
first guide wheels configured for guiding and driving the conveyor belts of the first pair of conveyor belts,
second guide wheels configured for guiding and driving the conveyor belts of the second pair of conveyor belts,
or, when the third pair of conveyor belts is present, third guide wheels configured for guiding and driving the conveyor belts of the third pair of conveyor belts,
   and such that the drive mechanism is configured to selectively ensure a movement of the first support(s), independently of the second supports, or a movement of the second support(s), independently of the first supports, or even where applicable in the presence of the third pair of conveyor belts, a movement of the third support(s), independently of the first support(s) and independently of the second support(s).

According to one embodiment, the stop means comprise:
for the or each first support, protruding stops on one face of the first support comprising the attachment groove, the protruding stops configured to engage with the longitudinal edges of at least one belt belonging to the belts of the second pair of conveyor belts, or even belonging to the belts of the third pair of conveyor belts,
for the or each second support, protruding stops on one face of the second support comprising the attachment groove, the protruding stops configured to engage with the longitudinal edges of at least one belt belonging to the belts of the first pair of conveyor belts, or even to the belts of the third pair of conveyor belts,
where applicable, for the or each third support, protruding stops on one face of the third support comprising the attachment groove, the protruding stops configured to engage with the longitudinal edges of at least one belt belonging to the belts of the first pair of conveyor belts, or even to the belts of the second pair of conveyor belts.

Preferably, the attachment groove has said open longitudinal end, the opposite longitudinal end of the attachment groove being a closed longitudinal end.

According to one embodiment, said at least one support comprises a base, a first wing and a second wing, extending protruding from the base, said base extending in width along a local direction of said at least one conveyor belt, and in length transversely to said at least one conveyor belt, said attachment groove formed in said base longitudinally to said base opening onto a lower surface of the base, the first wing and the second wing projecting from the top surface of the base so as to form a housing with a U-shaped cross-section for the elongate product.

According to one embodiment, said at least one support comprising the base including the attachment groove, the first wing and the second wing, in particular first support, second support, or even third support, is a one-piece element.

According to one embodiment, said at least one conveyor belt extends over a useful length between a zone for loading products into the housing or housings of said at least one support, and an unloading zone, distant from the loading zone, said at least one conveyor belt configured to ensure a movement of said at least one support from the loading zone to the unloading zone.

According to one embodiment, said at least one conveyor belt belongs to the first conveyor configured to ensure the movement of said at least one support in a first direction, and which said unloading zone comprises an unloading device comprising a second conveyor configured to ensure the movement of the products in a second direction, transverse to the first direction, from the housing(s) of said at least one support to one or more channels, in line with said at least one support.

According to one embodiment, said at least one attachment rib, in particular the first attachment ribs, second attachment ribs, or even third attachment ribs, is attached to said at least one belt by welding or glueing of the attachment rib on the outer face of said at least one conveyor belt. Preferably, said at least one attachment rib, in particular the first attachment ribs, second attachment ribs, or even third attachment ribs, is attached to said at least one conveyor belt, without piercing said at least one conveyor belt and said at least one support, in particular said means for fastening said at least one support to said at least one conveyor belt are lacking a fastening member such as screws passing through said at least one conveyor belt, said at least one rib, or even said at least one support.

According to one embodiment, said at least one conveyor belt, in particular the first pair of conveyor belts, the second pair of conveyor belts, or even the third pair of conveyor belts of the system, and said attachment rib are made of polyurethane, lacking a concavity forming a water retention zone.

According to a second aspect, the present disclosure relates to a method for conveying products, using a conveying system according to the present disclosure and wherein the products are food products such as sausages.

According to one embodiment of the conveying method using said conveying system comprising which is interposed between:
a conveying line ensuring an arrival of elongate products supplying the loading area of the conveying system continuously with said elongate products, on the one hand, and
an automated packaging station for elongate products, such as a thermoforming machine, in batch operation, on the other hand,
   and wherein an automation of the conveying system ensures control of the first supports, second supports, or even third supports independently in order to ensure a supply of the automated packaging station, in a discontinuous flow of elongate products exiting the unloading area, from the continuous flow of said conveying line supplying the loading area.

The present disclosure further relates, according to a third aspect, to a method for cleaning a conveying system according to the present disclosure comprising:
tool-less disassembly of said at least one support, by manually moving the stop means into said escape position and detaching said at least one support from said at least one conveyor belt by sliding extraction of the attachment rib from the attachment groove,
cleaning said at least one support and said at least one conveyor belt in the disassembled state of said at least one support and of said at least one conveyor belt.

### BRIEF DESCRIPTION OF THE DRAWINGS

Other features, details and advantages will appear upon reading the detailed description hereinafter, and on analysis of the appended drawings, wherein:

FIG. 1 is a view in perspective of a conveyor system according to the present disclosure, comprising a first conveyor and a second conveyor arranged at an unloading area of the first conveyor, the first conveyor and the second conveyor fully covered by two casings.

FIG. 2 is a view in perspective of the conveyor system according to FIG. 1, viewed from another angle, the housing of the first conveyor and the housing of the second conveyor being removed, the view illustrating a flow of elongate products, in parallel, at the unloading area, the second belt conveyor, being arranged above, oriented in a second direction, the second conveyor straddling between the loading area of the first conveyor, product-guide channels extending transversely to the first conveyor, aligned with housings of the supports of the first conveyor, a loading area of the first conveyor, being distant from the unloading area, the first conveyor configured to transfer the products contained in the housings of the supports of the first conveyor to the unloading area, by moving the supports along a first direction of the first conveyor, perpendicular to the second direction.

FIG. 3A is a sectional view passing through a vertical plane extending along the first direction, illustrating the conveyor belts in parallel, in the form of closed loops, and the guide wheels engaging with an inner surface of the conveyor belts to ensure the guidance and drive of the conveyor belts, the upper length of the belts supporting a plurality of supports forming individual housings respectively for the elongate products.

FIG. 3B is a perspective view of the conveyor belts in parallel, six in number, a first pair of conveyor belts supporting a first group of supports, so-called first supports, a second pair of conveyor belts supporting a second group of supports, so-called second supports, a third pair of conveyor belts supporting a third group of supports, so-called third supports.

FIG. 4 is a view of the various supports of the three different groups, arranged parallel to each other, the various supports each having a base, an attachment groove opening through a groove entry of a lower face of the base, and two wings, namely a first wing and a second wing protruding from the base of the upper face of said base.

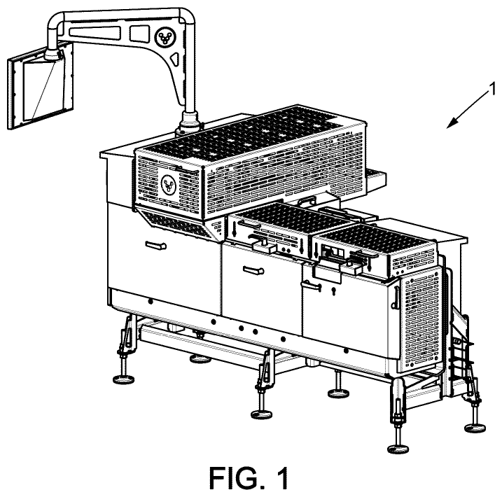

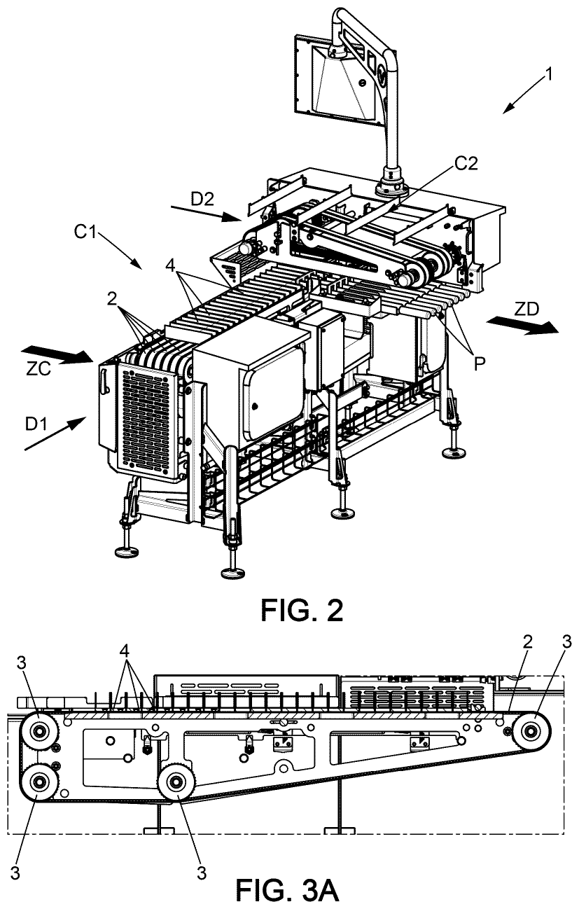

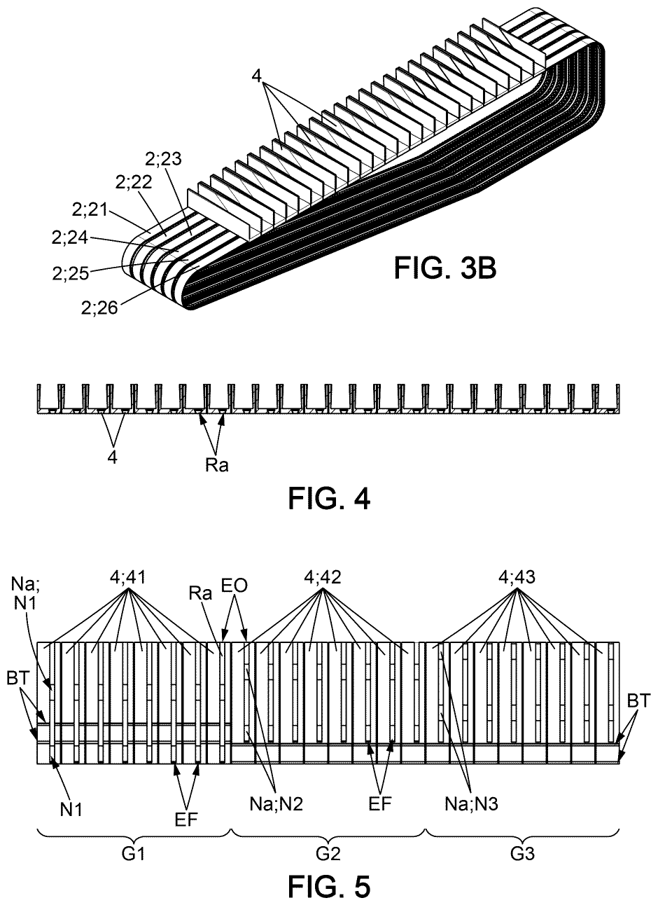

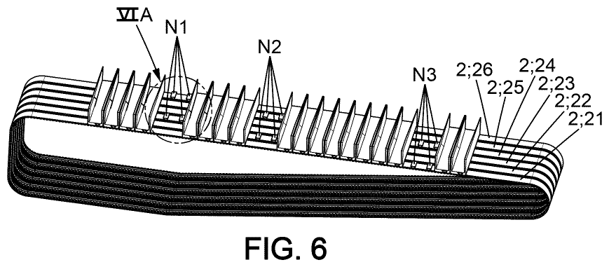

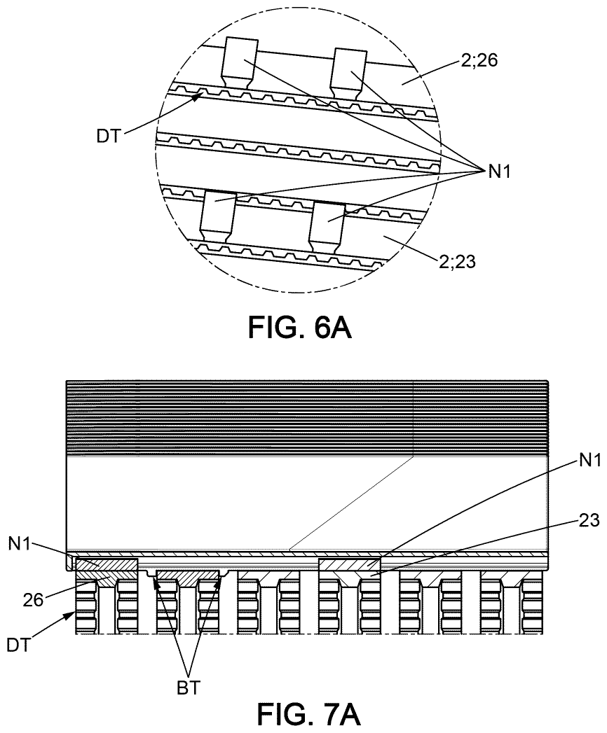

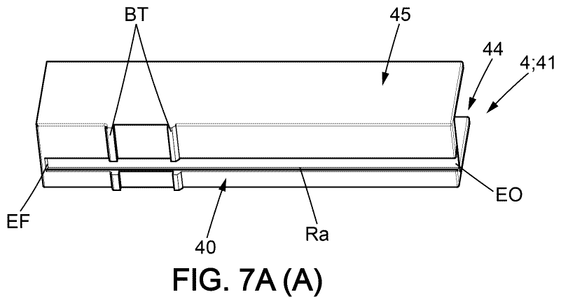

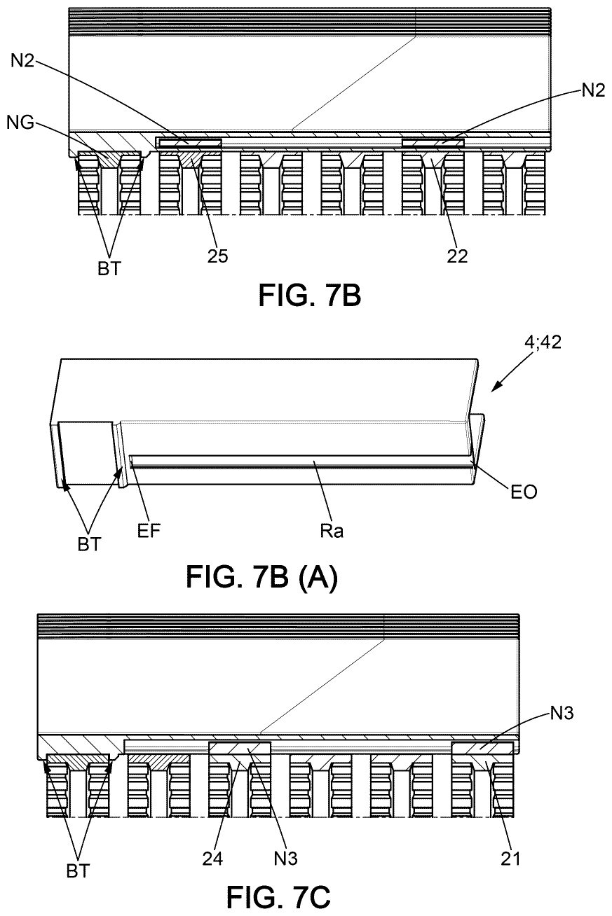

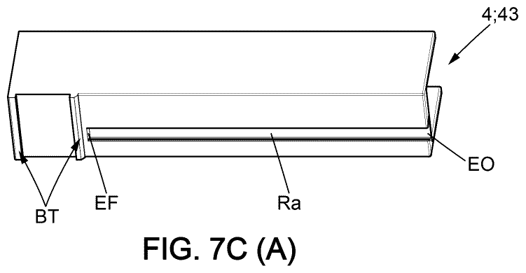

FIG. 5 is a view from below of FIG. 4, illustrating for each of the various supports of the first group, second group, and third group, in a notable manner:
the attachment groove,
the various positions of the two fastening ribs inside the fastening groove, namely respectively for the first supports of the first group, the second supports of the second group, and the third supports of the third group,
the positions of the protruding stops, under the lower face of the support, configured to prevent the sliding of the fastening ribs along the fastening grooves.

FIG. 6 is a perspective view of the conveyor belts and supports, some of the supports of the first group, the second group and the third group being hidden in order to illustrate the different positions:
first ribs secured to a third and sixth belt to secure the first supports,
second ribs secured to a second and fifth belt to secure the second supports,
third ribs secured to a first and fourth belt to secure the third supports,
   and wherein FIG. 6 illustrates an additional detail view of the first supports.

FIG. 6A is a detail view of FIG. 6.

FIG. 7A illustrates a sectional view illustrating the cooperation of the protruding stops with the edges of the fifth belt, as well as the first ribs integral with the third belt and the sixth belt.

FIG. 7AA a detailed view of the underside of the first support.

FIG. 7B illustrates a sectional view illustrating the cooperation of the protruding stops with the edges of the sixth belt, as well as the second ribs integral with the second belt and the fifth belt.

FIG. 7BA is a detail view of the underside of the second support.

FIG. 7C illustrates a sectional view illustrating the cooperation of the protruding stops with the edges of the sixth belt, as well as the third ribs integral with the first belt and the fourth belt.

FIG. 7CA is a detail view of the underside of the third support.

### DETAILED DESCRIPTION

The present disclosure relates to a conveying system 1 for elongate products, such as sausages, comprising at least one first conveyor having:
at least one conveyor belt 2 having an inner face and an outer face, and guide wheels 3 for said at least one conveyor belt configured to engage with the inner face of said at least one conveyor belt,
at least one support 4, comprising a housing extending in length configured to receive an elongate product,
means for fastening said at least one support 4 to said at least one conveyor belt 2, ensuring fastening said at least one support, locally oriented, in a direction transverse to said conveyor belt.

In general, said at least one conveyor belt can form a closed section loop. All or some of the guide wheels can be motorised to drive said conveyor belt 2. For this purpose, the at least one or more motorised wheels may have one or more teeth DT configured to mesh with one or more teeth on the inner face of said at least one conveyor belt.

The inner face of said at least one conveyor belt 2 can include a guide rib NG, projecting longitudinally to said at least one conveyor belt 2, configured to penetrate a guide groove, peripheral to the guide wheel. The cooperation between the guide rib and the guide groove ensures lateral holding and guiding of said at least one belt on the guide wheel.

Said at least one conveyor belt can comprise a single conveyor belt (embodiment not illustrated), and said at least one support 4 can typically comprise several supports 4 integral with said single conveyor belt. The various housings of the supports 4 extend parallel to one another, and typically form individual housings for the elongate products. The single conveyor belt forms a closed loop, and is guided in several positions with the guide wheels 3. At least some of the guide wheels are motorised and have the aforementioned teeth.

According to another embodiment (illustrated), said at least one conveyor belt 2 can comprise several conveyor belts 21 to 26, parallel to each other. The various supports 4 can be secured respectively to various conveyor belts 21 to 26 so as to form several groups of supports G1, G2, G3, movable independently of one another. To this end, the conveyor belts 21, 22, 23, 24, 25, 26 associated with the various groups of supports G1 can be driven independently of each other by motorised guide wheels.

According to the present disclosure, said attachment means comprise:
an attachment groove Ra of said at least one support 4 having at least one open longitudinal end EO, extending longitudinally to the support,
an attachment rib Na, integral with the outer face of said at least one conveyor belt 2, extending transversely to the local (longitudinal) direction of said at least one belt.

The attachment rib Na allows fixing of said at least one support 4 to said conveyor belt by inserting the attachment rib into said attachment groove Ra by said open longitudinal end EO, and fitting the attachment rib Na as far as a locking position of the attachment rib in the attachment groove ensuring the securing of the at least one support on said at least one belt.

Attachment rib Na and attachment groove Ra means a pair of attachment rib/attachment groove, with profiles such that, once fitted into the attachment groove, the attachment rib cannot be extracted by the entry of the attachment groove, longitudinal to said attachment groove; i.e. the attachment rib can only be extracted by the longitudinal open end EO, by sliding the rib along the groove.

As illustrated in the figures, the pair consisting of attachment rib/attachment groove may have a dovetail configuration: the attachment rib may have a trapezium profile comprising a small base of the trapezium integral with the outer face of said belt, and a large base of the trapezium forming a free end of the rib. The attachment groove may then include a complementary trapezoid profile.

Other attachment rib/attachment groove profiles may be envisaged, such as a T-shaped cross-section, preventing extraction through the groove entry, longitudinal to the attachment groove Ra.

The conveying system further preferably includes stop means BT, ensuring a locking of the fastening rib Na in the fastening groove Ra in the locking position by preventing the sliding of the fastening rib Na along the fastening rib Ra. Thus locking of said at least one support 4 to said at least one conveyor belt 2 which cannot be extracted by the open longitudinal end EO of the groove Ra is ensured.

The stop means BT can preferably be moved manually by an operator, from a position, typically stable, ensuring the locking of said at least one support 4, and as far as an escape position of the stop means releasing the sliding, allowing the disassembly of said at least one support 4 from the fastening rib Na. Moving of the stop means means a relative movement of the stop means relative to a part engaging with the stop means; such as said at least one belt, i.e. the operator can act either on the stop means or on the part such as the belt to obtain the escape position.

According to the present disclosure, said at least one attachment rib Na, is attached to said at least one conveyor belt, without piercing of said at least one conveyor belt 2 and of said at least one support 4.

In particular, said means for fastening said at least one support 4 to said at least one conveyor belt 2 are devoid of a fastening member such as screws passing through said at least one conveyor belt 2, said at least one rib Na, or also said at least one support 4.

According to one embodiment (not illustrated), the longitudinal end opposite the open longitudinal end EO may be a second open end, or even a closed longitudinal end EF (illustrated embodiment). Having a closed longitudinal end EF can be advantageous to avoid mounting errors when said support 4 has a mounting direction.

According to one embodiment, said at least one support 4 can comprise a base 40, a first wing 44 and a second wing 45, extending protruding from the base.

Said base 40 extends in width along the local direction of said at least one conveyor belt 2, and in length transversely to said at least one conveyor belt 2, said attachment groove Ra formed in said base longitudinally to said base opening onto a lower surface of the base, the first wing 44 and the second wing 45 projecting from the upper surface of the base so as to form the housing with a U-shaped cross-section for the elongate product.

The inner side walls of the first wing 44 and of the second wing 45, can be divergent over a first length section of the support 4, and in order to ensure a guidance of the products in the housing, when inserting the product through an open end of the housing.

Said at least one support comprising the base 40, including the attachment groove Ra, the first wing 44 and the second wing 45, in particular first support, second support, or even third support, can be a one-piece element. The support may be manufactured by moulding, for example, of a plastic material.

According to one embodiment, the various supports 4 may comprise several groups G1, G2, G3 of supports, independently movable, relative to one another.

Thus, said at least one support 4 can comprise at least one first support 41, or even several first supports 41 and at least one second support 4, or even several second supports 42, or even at least one third support 43, or even several third supports 43.

Said at least one conveyor belt may comprise:
a first pair of conveyor belts to which the (or each) first support 41 is fastened, by first fastening ribs N1 of the conveyor belts 23, 26 of the first pair of belts, fitted into the fastening groove Ra of the first support 41
a second pair of conveyor belts on which the (or each) second support 42 is fastened by second fastening ribs N2 of the conveyor belts 22, 25 of the second pair of belts, fitted into the fastening groove Ra of the second support 42,
or even a third pair of conveyor belts to which the or (each) third support 43 is fastened, by third fastening ribs N3 of the conveyor belts 21, 24 of the third pair of belts, fitted into the fastening groove Ra of the third support 43.

According to one embodiment, the first group G1 includes several first supports 41, for example eight (8) first supports 41, the second group G2 comprises several second supports 42, for example eight (8) second supports 42, and the third group G3 comprises several third supports 43, for example eight (8) third supports 43.

Said at least one conveyor belt 2 then comprises six conveyor belts in parallel, namely a first conveyor belt 21, a second conveyor belt 22, a third conveyor belt 23, a fourth conveyor belt 24, a fifth conveyor belt 25 and a sixth conveyor belt 26 respectively.

Each first support 41 is attached to two first ribs 41, respectively secured to two of the belts of the conveyors, for example to the third conveyor belt 23 and the sixth conveyor belt 26 (see FIG. 7A).

Each second support 42 is attached to two second ribs 42, respectively secured to two of the conveyor belts, for example to the second belt 22 and to the fifth belt 25 (See FIG. 7B).

Each third support 43 is attached to two third ribs 43, respectively secured to two of the conveyor belts, for example to the second belt 42, for example to the first belt 21 and to the fourth belt 24 (See FIG. 7B).

Said conveyor system may comprise a drive mechanism comprising:
first guide wheels configured for guiding and driving the conveyor belts 23, 26 of the first pair of conveyor belts,
second guide wheels configured for guiding and driving the conveyor belts 22, 25 of the second pair of conveyor belts,
or, when the third pair of conveyor belts is present, the third guide wheels configured for guiding and driving the conveyor belts of the third pair of conveyor belts.

The drive mechanism is configured to selectively ensure a movement of the first support(s) 41, independently of the second support(s) (or even independently of the third support(s) 43 if present), or a movement of the second support(s) 42, independently of the first support(s) (or even of the third support(s) if present), or even where applicable in the presence of the third pair of conveyor belts, a movement of the third support(s) 43, independently of the first supports or second supports.

According to one embodiment, the stop means BT may comprise:
for the or each first support 41, protruding stops on one face of the first support 41 comprising the attachment groove Ra, the protruding stops configured to engage with the longitudinal edges of at least one belt belonging to the belts 22, 25 of the second pair of conveyor belts, or even belonging to the belts 21, 24 of the third pair of conveyor belts,
for the or each second support 42, protruding stops on one face of the second support comprising the attachment groove, the protruding stops configured to engage with the longitudinal edges of at least one belt belonging to the belts of the first pair of conveyor belts, or even to the belts of the third pair of conveyor belts,
for the or each third support 43, protruding stops on one face of the third support comprising the attachment groove, the protruding stops configured to engage with the longitudinal edges of at least one belt belonging to the belts of the first pair of conveyor belts, or even to the belts of the second pair of conveyor belts.

For example, in FIG. 7A, the stop means of the first supports 41 comprise two protruding stops on the lower base surface which respectively abut against the two longitudinal edges of the fifth belt 25.

In FIG. 7B, the stop means of the second supports 42 comprise two protruding stops on the inner surface of the base which respectively abut against the two longitudinal edges of the sixth belt 26.

In FIG. 7C, the stop means of the third supports 43 comprise two protruding stops on the inner surface of the base which respectively abut against the two longitudinal edges of the sixth belt 26.

When fastening a support, i.e. during assembly, it is sufficient for an operator to fit the two fastening ribs Na of the pair of conveyor belts into the fastening groove of the support 4 to be fastened (in particular first support 41, second support 42 or third support 43) by inserting the ribs through the open longitudinal end EO, and slide the ribs as far as the locking position, by pressing slightly downwards the conveyor belt (or belts) intended to come into contact with the protruding stops to ensure securing with locking of the position of the support, then to release the pressure for the belt edges to lock on the protruding stops of the support. During disassembly, conversely, pressure on the conveyor belt in contact with the protruding stops allows the protruding stops to escape from the edges of the conveyor belt, allowing the support to slide until its disassembly is obtained by extracting the attachment ribs from the attachment groove. The mounting and dismounting of the supports 4 on said at least one conveyor belt 2 can be operated, quickly and simply, advantageously without tools.

Assembly and disassembly operations are particularly easy, preferably obtained without tools.

According to one embodiment, said at least one conveyor belt extends over a useful length between a zone ZC, for loading products in the housing(s) of said at least one support, and a remote unloading zone ZD, said at least one conveyor belt 2 configured to ensure a movement of said at least one support 4 from the loading zone ZC to the unloading zone ZD.

Generally, and as illustrated, the loading zone ZC extends over a first length section of said at least one conveyor belt 2, at a first end of the first conveyor, and while the unloading zone ZD extends, over a second length section of the conveyor belt 2, at a second end of said at least one conveyor belt 2.

Said at least one conveyor belt 2, including, where applicable, the various conveyor belts 21 to 26, belongs to a first conveyor C1 configured to ensure the movement of said at least one support in a first direction D1.

According to one embodiment, said unloading zone ZD comprises a loading device comprising a second conveyor C2 configured to ensure the movement of the elongate products P along a second direction D2 transverse to the first direction D1, from the housing(s) of said at least one support 4 to one or more channels extending therefrom.

Guides including channels are provided at the side of the ZC unloading area to ensure the individual guidance of elongate products parallel to each other. The second conveyor C2 can be a belt conveyor, which is oriented in the second direction D2, arranged above and straddling above the unloading zone ZD of the first conveyor C1 and the channels ensuring the guidance of the elongate products.

The conveyor belts of the second conveyor C2 are spaced according to the spacing of the guide channels, and engage with the upper surfaces of the elongate products to ensure the driving of the elongate products, resting in the housings of the various supports 4 and as far as channels respectively in line with the housings of the different supports 4 of the first conveyor, the channels aligned with the housings of the supports.

During loading, the various supports 4 being loaded belonging to the same group (for example of the first group G1, or of the second group, or even of the third group) are typically moved step by step, according to the spacing between two housings two consecutive supports in order to be loaded typically individually, one after the other in elongate products from a queue of elongate products running continuously. The supports 4 of another group (for example of the second group G2), which have previously been loaded, can be moved to the unloading zone ZD as a background task with the loading of the first supports 41 of the first group G1.

The supports of yet another group (for example of the third group G3) can be unloaded at the unloading zone ZD, and before being moved again to the loading zone ZC, as a background task with the loading. The second conveyor C2 can make it possible to unload the supports of the group simultaneously, thanks to these various conveyor belts.

Preferably, said at least one attachment rib Na, in particular each of the first attachment ribs N1, the second attachment ribs N2, or even the third attachment ribs Na), is attached to said at least one belt 2 by welding or glueing the attachment rib Na on the outer face of said at least one conveyor belt.

Preferably, said at least one attachment rib Na, in particular each of the first attachment ribs N1, the second attachment ribs N2, or even the third attachment ribs, is attached to said at least one conveyor belt, without piercing said at least one conveyor belt 2 and said at least one support.

### INDUSTRIAL APPLICATION

The conveying system by its method of fastening said at least one support 4 to said at least one conveyor belt 2 advantageously makes it possible to fasten the support(s) 4 to the belt(s) 2, preferably without drilling the latter, in particular by means of fastening members.

Cleaning of the supports 4 and the belts is thereby facilitated and hygiene is improved compared with the prior art presented, which has perforations in the belt giving rise to gaps likely to trap moisture.

Preferably, the positioning of the supports 4 on the belts 21 to 26 can be carried out without tools, facilitating the assembly and disassembly operations.

The present disclosure further relates to a method for conveying products, using a conveying system according to the present disclosure wherein the products are food products such as sausages.

According to one embodiment of the method, said conveying system may be interposed between:
a conveying line ensuring the arrival of elongate products feeding the loading area of the conveying system, preferably said elongate products in continuous runs, in a queue one after the other, on the one hand, and
an automated packaging station for elongate products, in discontinuous operation, such as a thermoforming machine, on the other hand.

Advantageously, an automation of the conveying system makes it possible to provide a control, of the first supports 41, of the second supports 42, or even of the third supports independently, in order to ensure a supply of the automated packaging station, in a discontinuous flow of elongate products exiting the unloading zone, from the continuous flow of said conveying line arriving at the loading zone.

The present disclosure also relates to a method for maintaining a conveying system according to the present disclosure, comprising:
tool-less disassembly of said at least one support 4, (in particular the first supports, the second supports, and third supports), by manually moving the stop means into said escape position and detaching said at least one support 4 from said at least one conveyor belt 2 by sliding extraction of the attachment rib Na from the attachment groove Ra
cleaning said at least one support 4 (in particular the first supports, the second supports, and third supports), and said at least one conveyor belt 2 in the disassembled state of said at least one support 4 and of said at least one conveyor belt 2.

Said at least one conveyor belt 2, in particular the first pair of conveyor belts, the second pair of conveyor belts, or even the third pair of conveyor belts of the system, and said attachment rib Na may be made of polyurethane, lacking a concavity forming a water retention zone.

At regular intervals, after each production campaign, the conveying system according to the present disclosure may be disassembled to ensure a high degree of cleaning, and easily, advantageously without tools.

### LIST OF REFERENCE SIGNS

1: Conveying system,
C1 first conveyor,
D1. First direction (first conveyor)
2. At least one conveyor belt,
21, 22, 23, 24, 25, 26. First, second, third, fourth, fifth and sixth conveyor belts
3. Guide wheel,
DT. Teeth (belonging to the guide wheel or to the inner face of said conveyor belt),
4. At least one support,
40. Base,
44, 45. First wing and second wing,
G1. First group (of supports)
41. First supports (belonging to the first group),
G2. Second group (of supports),
42. Second supports (belonging to the second group),
G3. Third group (of supports)
43. Third supports (belonging to the third group),
Ra. Attachment grooves,
EO, EF. Open longitudinal end and closed longitudinal end respectively
Na. Fastening ribs,
N1. First fastening ribs (secured to the belts of the first pair of conveyor belts and securing the first supports),
N2. Second fastening ribs (secured to the belts of the second pair of conveyor belts and securing the second supports),
N3. Third fastening ribs (secured to the belts of the third pair of conveyor belts,
ZC. Loading area,
ZD. Unloading area,
C2. Second conveyor.

1) A conveying system (1) for elongate products, such as sausages, comprising a first conveyor (C1) comprising:
at least one conveyor belt having an inner face and an outer face, and guide wheels for said at least one conveyor belt configured to engage with the inner face of said at least one conveyor belt,
at least one support, comprising a housing extending in length configured for receiving an elongate product,
means for fastening said at least one support to said at least one conveyor belt, ensuring fastening of said at least one support, locally oriented, in a direction transverse to said conveyor belt
said fastening means comprising:
a groove (Ra) for attaching said at least one support having at least one open longitudinal end (EO), extending longitudinally to the support,
an attachment rib (Na), secured to the outer face of said at least one conveyor belt, extending transversely to the local direction of said at least one belt, allowing fastening of said at least one support to said conveyor belt by inserting the attachment rib into said attachment groove by said open longitudinal end, and fitting the rib as far as a locking position of the attachment rib in the attachment groove ensuring the attachment of the at least one support on said at least one belt,
stop means (BT), ensuring a locking of the attachment rib in the attachment groove in the locking position by preventing the sliding of the attachment rib along the attachment rib, and wherein:
said at least one support comprises at least one first support, or even first supports and at least one second support, or even second supports, or even at least one third support, or even third supports
said at least one conveyor belt comprises:
a first pair of conveyor belts to which the or each first support is fastened, by first attachment ribs (N1) of the conveyor belts of the first pair of belts, fitted into the attachment groove (R1) of the first support
a second pair of conveyor belts to which the or each second support is fastened by second attachment ribs (N2) of the conveyor belts of the second pair of belts, fitted into the attachment groove (Ra) of the second support,
or even a third pair of conveyor belts to which the or each third support is fastened, by third fastening ribs (N3) of the conveyor belts of the third pair of belts, fitted into the fastening groove (Ra) of the third support, and
wherein said first conveyor (C1) has a drive mechanism comprising:
first guide wheels configured for guiding and driving the conveyor belts of the first pair of conveyor belts,
second guide wheels configured for guiding and driving the conveyor belts of the second pair of conveyor belts,
or, when the third pair of conveyor belts is present, third guide wheels configured for guiding and driving the conveyor belts of the third pair of conveyor belts,
and so that the drive mechanism is configured to selectively ensure a movement of the first support(s), independently of the second supports, or a movement of the second support(s), independently of the first supports, or even, where applicable, when the third pair of conveyor belts it is present, a movement of the third support(s), independently of the first support(s) and independently of the second support(s).

2) The conveying system according to claim 1, wherein the stop means (BT) are configured to be moved manually by an operator, from a position ensuring the locking of said at least one support on said at least one conveyor belt, and as far as an escape position of the stop means releasing the sliding, allowing the detachment of said at least one support from said conveyor belt by sliding extraction of the attachment rib (Na) from the mounting groove (Ra).

3) The conveying system according to claim 2, wherein the stop means (BT) comprise:
for the or each first support, stops protruding from a face of the first support comprising the attachment groove (Ra), the protruding stops configured to engage with the longitudinal edges of at least one belt belonging to the belts of the second pair of conveyor belts, or even belonging to the belts of the third pair of conveyor belts,
for the or each second support, protruding stops on one face of the second support comprising the attachment groove, the protruding stops configured to engage with the longitudinal edges of at least one belt belonging to the belts of the first pair of conveyor belts, or even to the belts of the third pair of conveyor belts,
where applicable, for the or each third support, protruding stops on one face of the third support comprising the attachment groove, the protruding stops configured to engage with the longitudinal edges of at least one belt belonging to the belts of the first pair of conveyor belts, or even to the belts of the second pair of conveyor belts.

4) The conveying system according to claim 1, wherein the attachment groove (Ra) has said open longitudinal end (EO), the opposite longitudinal end of the attachment groove being a closed longitudinal end (EF).

5) The conveying system according to claim 1, wherein said at least one support comprises a base, a first wing and a second wing, extending protruding from the base, said base extending in width along the local direction of said at least one conveyor belt, and in length transversely to said at least one conveyor belt, said attachment groove (Ra) formed in said base longitudinally to said base opening onto a lower surface of the base, the first wing and the second wing projecting from the upper surface of the base so as to form a housing with a U-shaped cross section for the product.

6) The conveying system according to claim 5, wherein said at least one support comprising the base including the attachment groove (Ra), the first wing and the second wing, in particular first support, second support, or even third support, is a one-piece element.

7) The conveying system according to claim 1, wherein said at least one conveyor belt extends over a useful length between a zone (ZC) for loading products in the housing(s) of said at least one support, and a remote unloading zone (ZD), said at least one conveyor belt configured to ensure a movement of said at least one support from the loading zone (ZC) to the unloading zone (ZD).

8) The conveying system according to claim 1, wherein said at least one conveyor belt belongs to the first conveyor (C1) configured to ensure the movement of said at least support in a first direction (D1), and wherein said unloading zone comprises an unloading device comprising a second conveyor (C2) configured to ensure the movement of the products in a second direction (D2) transverse to the first direction (D1), from the housing(s) of said at least one support to one or more channels, in line with said at least one support.

9) The conveying system according to claim 1, wherein said at least one attachment rib (Na), in particular the first attachment ribs (N1), second attachment ribs (N2), or even third attachment ribs (N3), is attached to said at least one belt by welding or glueing, of the attachment rib (Na) on the outer face of said at least one conveyor belt.

10) The conveying system according to claim 1, said at least one attachment rib (Na), in particular the first attachment ribs (N1), second attachment ribs (N2), or even third attachment ribs, is attached to said at least one conveyor belt, without piercing said at least one conveyor belt and said at least one support, in particular said means for fastening said at least one support to said at least one conveyor belt does not have a fastening member such as a screw passing through said at least one conveyor belt, said at least one rib (Na), or said at least one support.

11) The conveying system according to claim 1, wherein said at least one conveyor belt and said attachment rib (Na), are made of polyurethane, lacking a concavity forming a water retention zone.

12) A method for conveying products, using a conveying system according to claim 1, wherein the products are food products such as sausages.

13) The method according to claim 12, further comprising:
a conveying line ensuring an arrival of elongate products supplying the loading area of the conveying system continuously with said elongate products, on the one hand, and
an automated packaging station for elongate products, such as a thermoforming machine, in batch operation, on the other hand,
and wherein an automation of the conveying system ensures control of the first supports, second supports, or even third supports independently in order to ensure a supply of the automated packaging station, in a discontinuous flow of elongate products exiting the unloading zone (ZD) from the continuous flow of said conveying line supplying the loading zone (ZC).

14) A method for cleaning a conveyor system according to claim 2 comprising:
tool-less disassembly of said at least one support, by manually moving the stop means into said escape position and detaching said at least one support from said at least one conveyor belt by sliding extraction of the attachment rib (Na) from the attachment groove (Ra)
cleaning of said at least one support and of said at least one conveyor belt in the disassembled state of said at least one support and of said at least one conveyor belt.

15) A method for assembling a conveying system according to claim 3 comprising:
fitting the two fastening ribs (Na) of the pair of conveyor belts into the fastening groove of the support to fasten in particular the first support, second support or third support by inserting the ribs through the open longitudinal end (EO),
sliding the ribs as far as the locking position, by pressing down the conveyor belt, or belts, designed to come into contact with the protruding stops to ensure fixation with locking of the support position, then releasing the pressure so that the belt edges lock onto the protruding stops of the support.

16) A method for dismantling a conveyor system according to claim 3, comprising:
exerting pressure on the conveyor belt in contact with the protruding stops so as to make the protruding stops escape from the edges of the pair of conveyor belts, and
sliding the support until it is removed by extracting the fastening ribs from the fastening groove.
